(19) United States
(12) Patent Application Publication
(10) Pub. No.: US 2023/0162028 A1
(43) Pub. Date: May 25, 2023

(54) EXTRACTING AND TRANSFERRING FEATURE REPRESENTATIONS BETWEEN MODELS

(71) Applicants: Ricardo Chiang Shih, Madison, WI (US); David Sandai Kurokawa, Kirkland, WA (US); Shayak Sen, San Mateo, CA (US)

(72) Inventors: Ricardo Chiang Shih, Madison, WI (US); David Sandai Kurokawa, Kirkland, WA (US); Shayak Sen, San Mateo, CA (US)

(21) Appl. No.: 17/897,760

(22) Filed: Aug. 29, 2022

Related U.S. Application Data
(60) Provisional application No. 63/248,876, filed on Sep. 27, 2021.

(51) Int. Cl. G06N 3/08; G06N 3/04

(52) U.S. Cl. CPC G06N 3/08; G06N 3/0445; G06N 3/0454

(57) ABSTRACT

Computer accesses source model and destination model. Each of source model and destination model is configured to compute output value based on values for each of set of features. Computer develops influence model for source model. Influence model computes a relative influence value for one or more feature of source model. Sum of all relative influence values corresponds to output value of source model. Computer determines a curve function mapping the one or more features of source model to the relative influence value of the one or more features. Computer creates an augmented input feature set by applying the curve function to augment the one or more features of source model. Computer modifies destination model by adding, to destination model, a preprocessing function to generate feature values for features of the augmented input feature set. Computer retrains modified destination model to leverage the curve function and the augmented input feature set.

This application claims the benefit of priority under 35 U.S.C. 119(e) to U.S. Provisional Pat. Application Serial No. 63/248,876, filed Sep. 27, 2021, which is incorporated herein by reference in its entirety.

### TECHNICAL FIELD

Embodiments pertain to computer architecture. Some embodiments relate to machine learning. Some embodiments relate to extracting and transferring feature representations between models.

### BACKGROUND

Machine learning models vary from more complex and more accurate models which run on expensive servers to less complex and less accurate models which can run on lower cost client computing devices. Techniques for improving the accuracy of the less complex models without significantly increasing complexity may be desirable.

### BRIEF DESCRIPTION OF THE DRAWINGS

FIG. 1 illustrates the training and use of a machine-learning program, in accordance with some embodiments.

FIG. 2 illustrates an example neural network, in accordance with some embodiments.

FIG. 3 illustrates the training of an image recognition machine learning program, in accordance with some embodiments.

FIG. 4 illustrates the feature-extraction process and classifier training, in accordance with some embodiments.

FIG. 5 is a block diagram of a computing machine, in accordance with some embodiments.

FIG. 6 illustrates an example graph relating feature value to influence, and a curve fitting for predicting influence from feature value, in accordance with some embodiments.

FIGS. 7A-7F illustrate a series of influence sensitivity plots of one feature partitioned by time, in accordance with some embodiments.

FIG. 8 illustrates an influence sensitivity plot (ISP) focusing on the time dimension showcasing temporal feature representation, in accordance with some embodiments.

FIG. 9 is a flowchart of an example process associated with extracting and transferring feature representations between models, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Aspects of the present technology may be implemented as part of a computer system. The computer system may be one physical machine, or may be distributed among multiple physical machines, such as by role or function, or by process thread in the case of a cloud computing distributed model. In various embodiments, aspects of the technology may be configured to run in virtual machines that in turn are executed on one or more physical machines. It will be understood by persons of skill in the art that features of the technology may be realized by a variety of different suitable machine implementations.

The system includes various engines, each of which is constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

As used herein, the term “model” encompasses its plain and ordinary meaning. A model may include, among other things, one or more engines which receive an input and compute an output based on the input. The output may be a classification. For example, an image file may be classified as depicting a cat or not depicting a cat. Alternatively, the image file may be assigned a numeric score indicating a likelihood whether the image file depicts the cat, and image files with a score exceeding a threshold (e.g., 0.9 or 0.95) may be determined to depict the cat.

This document may reference a specific number of things (e.g., “six mobile devices”). Unless explicitly set forth otherwise, the numbers provided are examples only and may be replaced with any positive integer, integer or real number, as would make sense for a given situation. For example, “six mobile devices” may, in alternative embodiments, include any positive integer number of mobile devices. Unless otherwise mentioned, an object referred to in singular form (e.g., “a computer” or “the computer”) may include one or multiple objects (e.g., “the computer” may refer to one or multiple computers).

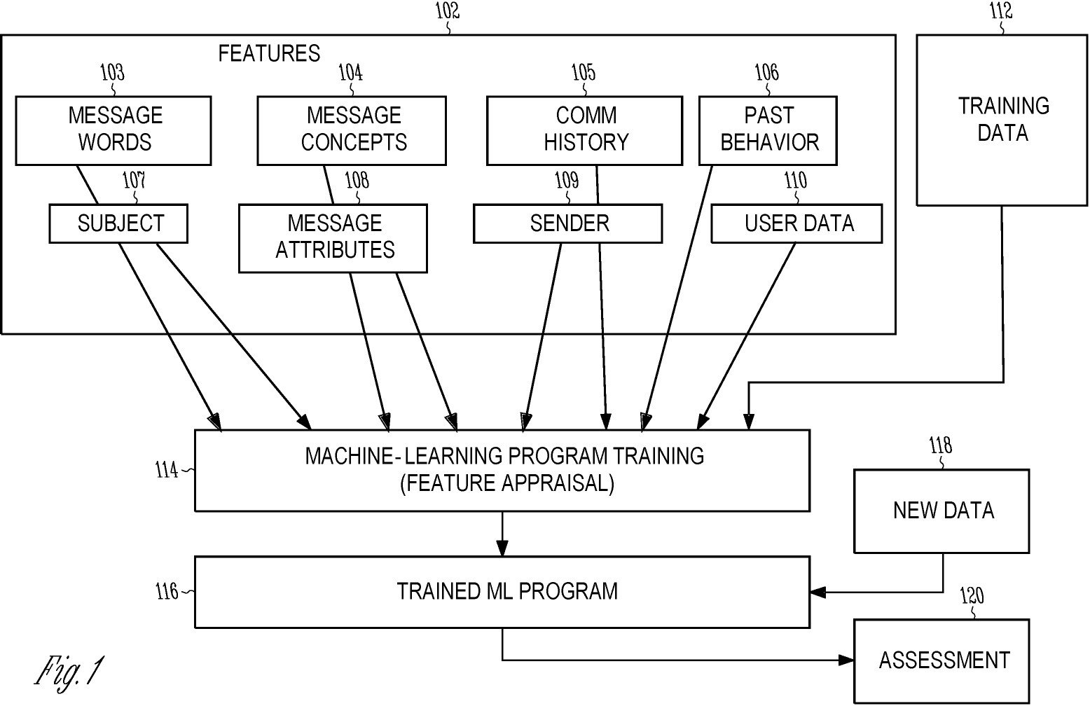

FIG. 1 illustrates the training and use of a machine-learning program, according to some example embodiments. In some example embodiments, machine-learning programs (MLPs), also referred to as machine-learning algorithms or tools, are utilized to perform operations associated with machine learning tasks, such as image recognition or machine translation.

Machine learning is a field of study that gives computers the ability to learn without being explicitly programmed. Machine learning explores the study and construction of algorithms, also referred to herein as tools, which may learn from existing data and make predictions about new data. Such machine-learning tools operate by building a model from example training data 112 in order to make data-driven predictions or decisions expressed as outputs or assessments 120. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange). Regression algorithms aim at quantifying some items (for example, by providing a value that is a real number). The machine-learning algorithms utilize the training data 112 to find correlations among identified features 102 that affect the outcome.

The machine-learning algorithms utilize features 102 for analyzing the data to generate assessments 120. A feature 102 is an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs.

In one example embodiment, the features 102 may be of different types and may include one or more of words of the message 103, message concepts 104, communication history 105, past user behavior 106, subject of the message 107, other message attributes 108, sender 109, and user data 110.

The machine-learning algorithms utilize the training data 112 to find correlations among the identified features 102 that affect the outcome or assessment 120. In some example embodiments, the training data 112 includes labeled data, which is known data for one or more identified features 102 and one or more outcomes, such as detecting communication patterns, detecting the meaning of the message, generating a summary of the message, detecting action items in the message, detecting urgency in the message, detecting a relationship of the user to the sender, calculating score attributes, calculating message scores, etc.

With the training data 112 and the identified features 102, the machine-learning tool is trained at operation 114. The machine-learning tool appraises the value of the features 102 as they correlate to the training data 112. The result of the training is the trained machine-learning program 116.

When the machine-learning program 116 is used to perform an assessment, new data 118 is provided as an input to the trained machine-learning program 116, and the machine-learning program 116 generates the assessment 120 as output. For example, when a message is checked for an action item, the machine-learning program utilizes the message content and message metadata to determine if there is a request for an action in the message.

Machine learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the models are evaluated and the values of their variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs -having reached a performance plateau - the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusterings is used to select a model that produces the clearest bounds for its clusters of data.

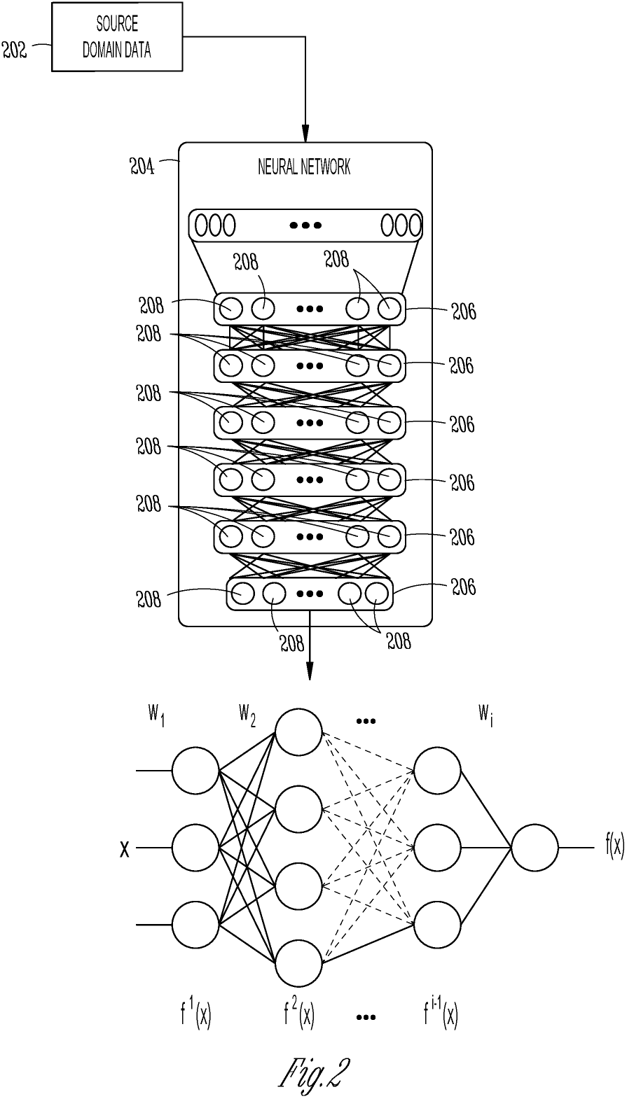

FIG. 2 illustrates an example neural network 204, in accordance with some embodiments. As shown, the neural network 204 receives, as input, source domain data 202. The input is passed through a plurality of layers 206 to arrive at an output. Each layer 206 includes multiple neurons 208. The neurons 208 receive input from neurons of a previous layer and apply weights to the values received from those neurons in order to generate a neuron output. The neuron outputs from the final layer 206 are combined to generate the output of the neural network 204.

As illustrated at the bottom of FIG. 2, the input is a vector x. The input is passed through multiple layers 206, where weights W₁, W₂, ..., Wᵢ are applied to the input to each layer to arrive at ƒ¹(x),ƒ²(x), ... ƒ⁻¹(x), until finally the output ƒ(x) is computed.

In some example embodiments, the neural network 204 (e.g., deep learning, deep convolutional, or recurrent neural network) comprises a series of neurons 208, such as Long Short Term Memory (LSTM) nodes, arranged into a network. A neuron 208 is an architectural element used in data processing and artificial intelligence, particularly machine learning, which includes memory that may determine when to “remember” and when to “forget” values held in that memory based on the weights of inputs provided to the given neuron 208. Each of the neurons 208 used herein are configured to accept a predefined number of inputs from other neurons 208 in the neural network 204 to provide relational and sub-relational outputs for the content of the frames being analyzed. Individual neurons 208 may be chained together and/or organized into tree structures in various configurations of neural networks to provide interactions and relationship learning modeling for how each of the frames in an utterance are related to one another.

For example, an LSTM node serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of feature is related to that of an explanatory variable used in statistical techniques such as linear regression. Further, deep features represent the output of nodes in hidden layers of the deep neural network.

A neural network, sometimes referred to as an artificial neural network, is a computing system/apparatus based on consideration of biological neural networks of animal brains. Such systems/apparatus progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node’s activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a predetermined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

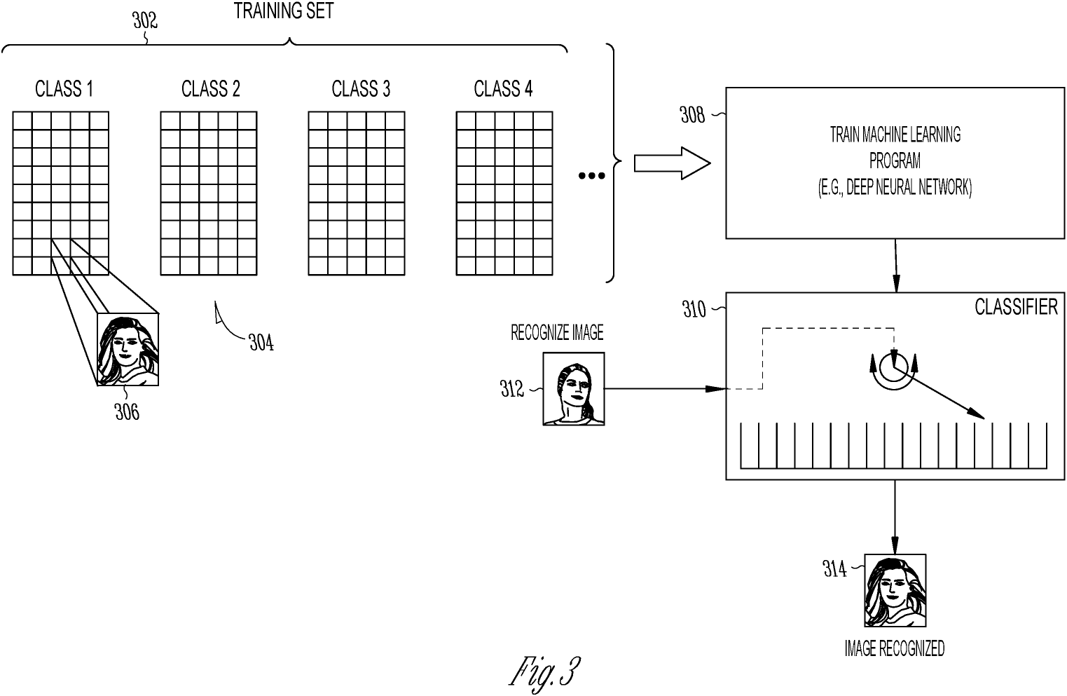

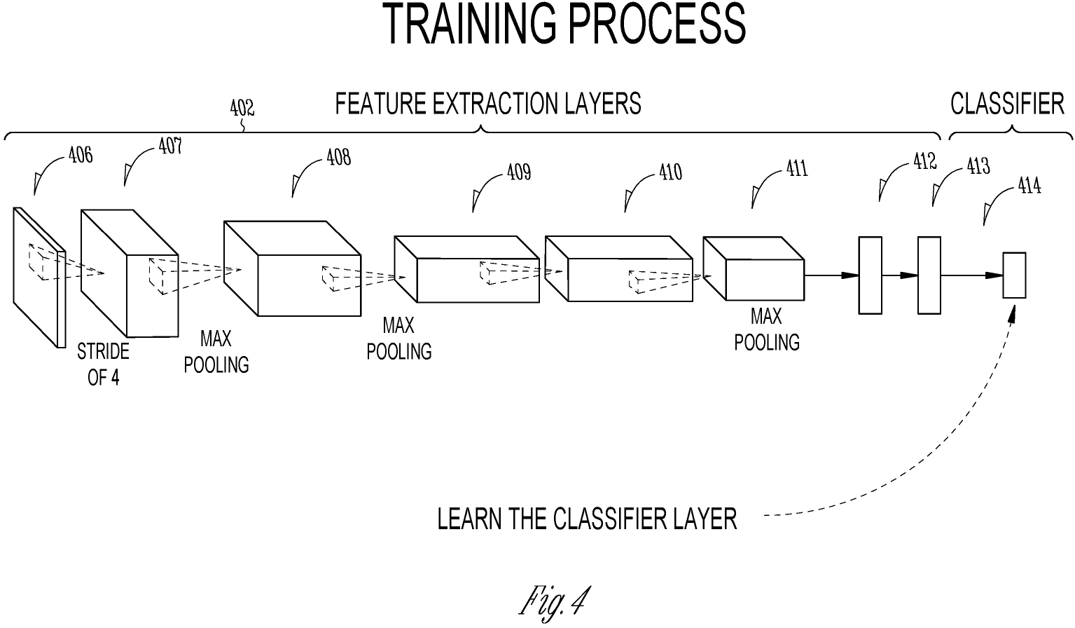

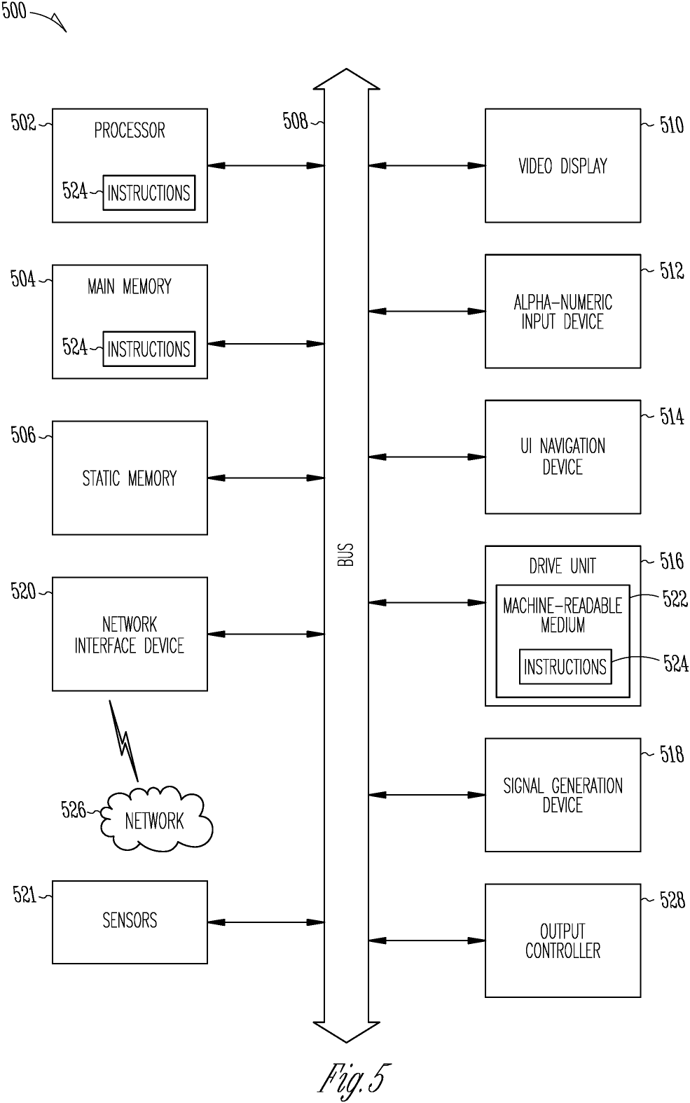

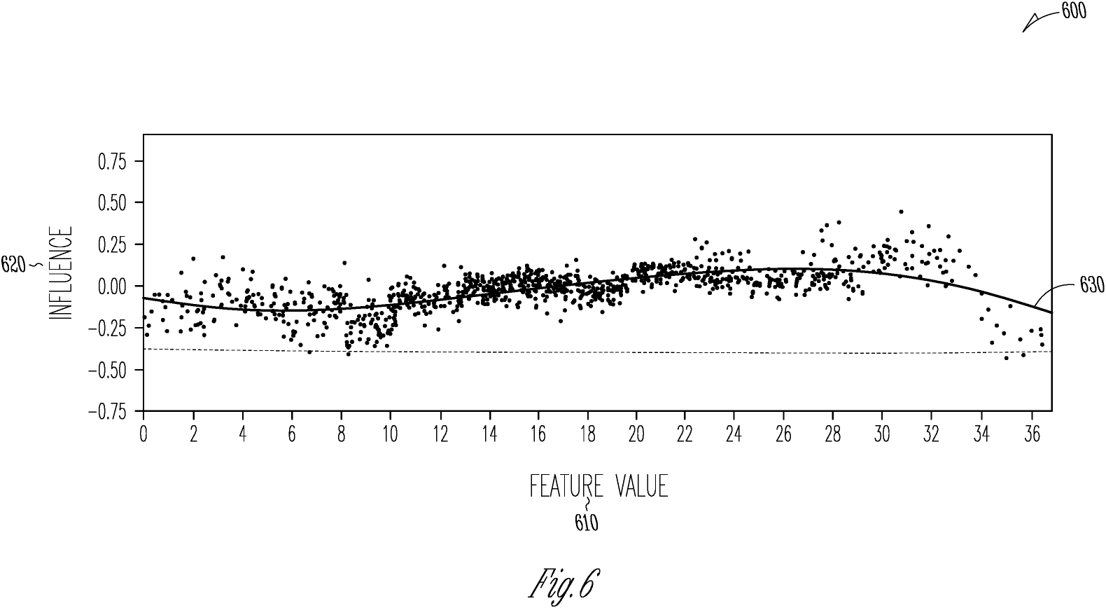

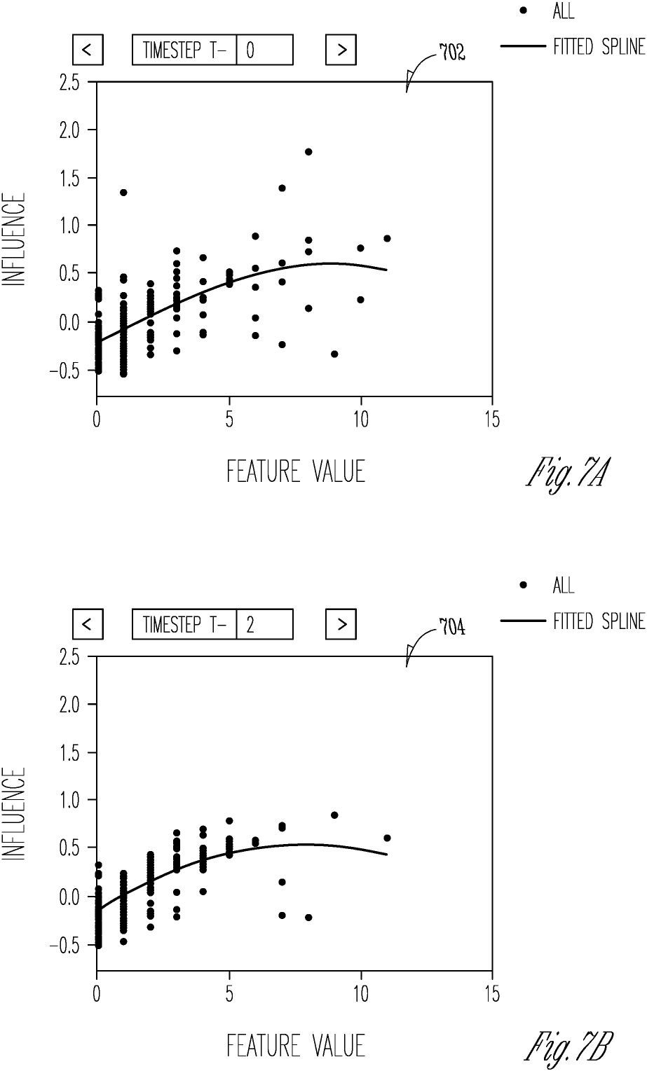

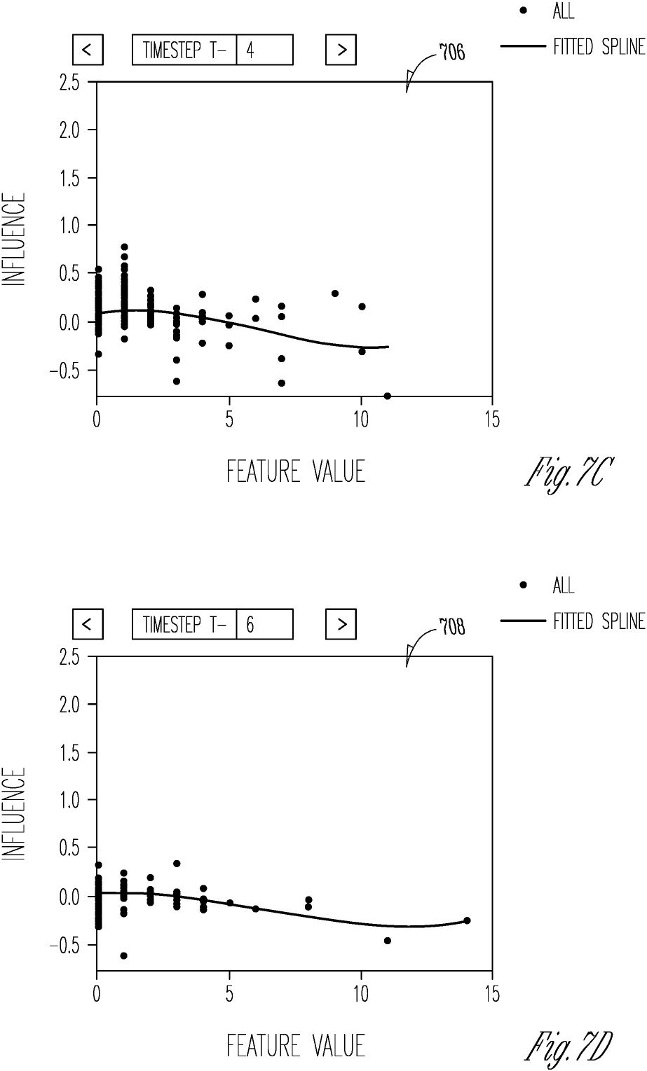

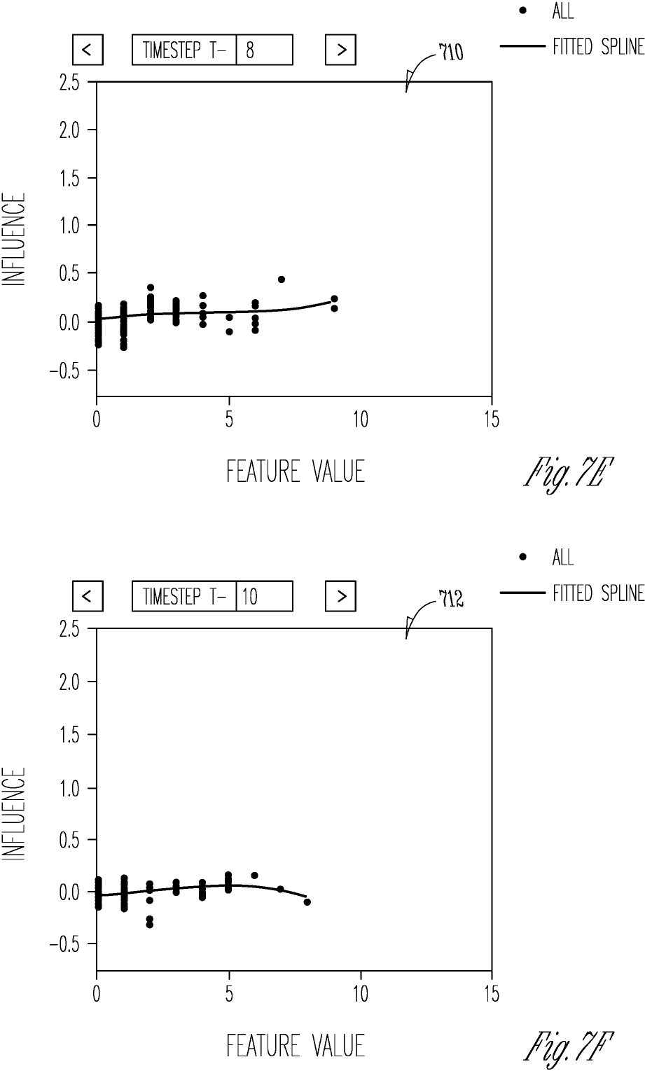

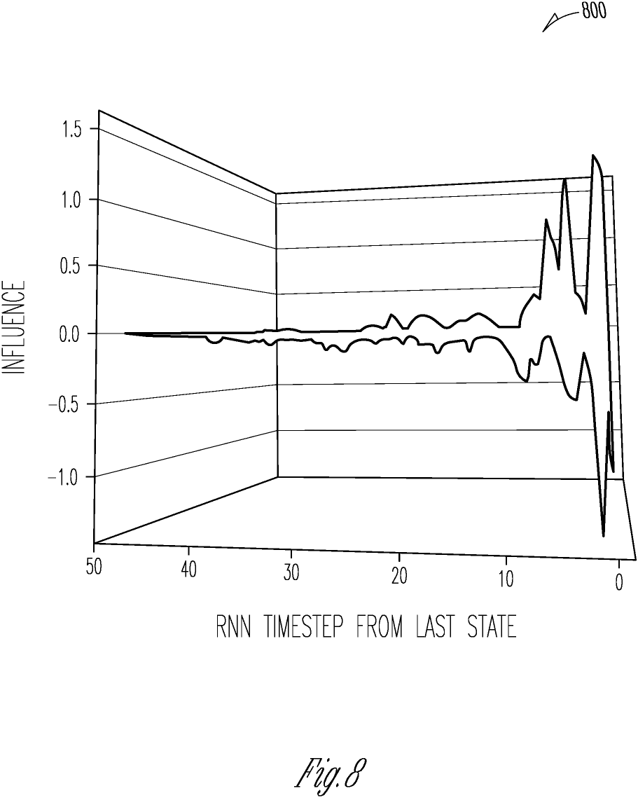

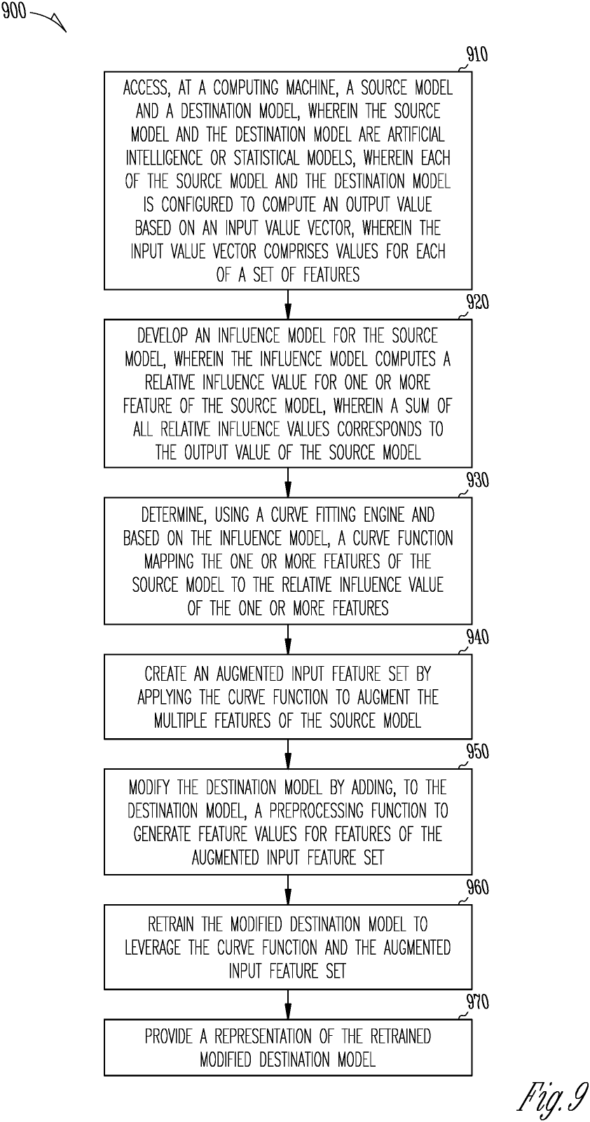

FIG. 3 illustrates the training of an image recognition machine learning program, in accordance with some embodiments. The machine learning program may be implemented at one or more computing machines. A training set 302 includes multiple classes 304. Each class 304 includes multiple images 306 associated with the class. Each class 304 may correspond to a type of object in the image 306 (e.g., a digit 0-9, a man or a woman, a cat or a dog, etc.). In one example, the machine learning program is trained to recognize images of the presidents of the United States, and each class corresponds to each president (e.g., one class corresponds to Barack Obama, one class corresponds to George W. Bush, one class corresponds to Bill Clinton, etc.). At block 308 the machine learning program is trained, for example, using a deep neural network. A trained classifier 310, generated by the training of block 308, recognizes an image 312, and the image 314 is recognized. For example, if the image 312 is a photograph of Bill Clinton, the classifier recognizes the image as corresponding to Bill Clinton.

FIG. 3 illustrates the training of a classifier, according to some example embodiments. A machine learning algorithm is designed for recognizing faces, and a training set 302 includes data that maps a sample to a class 304 (e.g., a class includes all the images of purses). The classes may also be referred to as labels. Although embodiments presented herein are presented with reference to object recognition, the same principles may be applied to train machine-learning programs used for recognizing any type of items.

The training set 302 includes a plurality of images 306 for each class 304 (e.g., image 306), and each image is associated with one of the categories to be recognized (e.g., a class). The machine learning program is trained 308 with the training data to generate a classifier 310 operable to recognize images. In some example embodiments, the machine learning program is a DNN.

When an input image 312 is to be recognized, the classifier 310 analyzes the input image 312 to identify the class (e.g., class of image 314) corresponding to the input image 312.

FIG. 4 illustrates the feature-extraction process and classifier training, according to some example embodiments. Training the classifier may be divided into feature extraction layers 402 and classifier layer 414. Each image is analyzed in sequence by a plurality of layers 406-413 in the feature-extraction layers 402.

With the development of deep convolutional neural networks, the focus in face recognition has been to learn a good face feature space, in which faces of the same person are close to each other, and faces of different persons are far away from each other. For example, the verification task with the LFW (Labeled Faces in the Wild) dataset has been often used for face verification.

Many face identification tasks (e.g., MegaFace and LFW) are based on a similarity comparison between the images in the gallery set and the query set, which is essentially a K-nearest-neighborhood (KNN) method to estimate the person’s identity. In the ideal case, there is a good face feature extractor (inter-class distance is always larger than the intra-class distance), and the KNN method is adequate to estimate the person’s identity.

Feature extraction is a process to reduce the amount of resources required to describe a large set of data. When performing analysis of complex data, one of the major problems stems from the number of variables involved. Analysis with a large number of variables generally requires a large amount of memory and computational power, and it may cause a classification algorithm to overfit to training samples and generalize poorly to new samples. Feature extraction is a general term describing methods of constructing combinations of variables to get around these large data-set problems while still describing the data with sufficient accuracy for the desired purpose.

In some example embodiments, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with very sparse data) to smaller vectors capturing the same, or similar, amount of information.

Determining a subset of the initial features is called feature selection. The selected features are expected to contain the relevant information from the input data, so that the desired task can be performed by using this reduced representation instead of the complete initial data. DNN utilizes a stack of layers, where each layer performs a function. For example, the layer could be a convolution, a non-linear transform, the calculation of an average, etc. Eventually this DNN produces outputs by classifier layer 414. In FIG. 4, the data travels from left to right and the features are extracted. The goal of training the neural network is to find the parameters of all the layers that make them adequate for the desired task.

As shown in FIG. 4, a “stride of 4” filter is applied at layer 406, and max pooling is applied at layers 407-413. The stride controls how the filter convolves around the input volume. “Stride of 4” refers to the filter convolving around the input volume four units at a time. Max pooling refers to down-sampling by selecting the maximum value in each max pooled region.

In some example embodiments, the structure of each layer is predefined. For example, a convolution layer may contain small convolution kernels and their respective convolution parameters, and a summation layer may calculate the sum, or the weighted sum, of two pixels of the input image. Training assists in defining the weight coefficients for the summation.

One way to improve the performance of DNNs is to identify newer structures for the feature-extraction layers, and another way is by improving the way the parameters are identified at the different layers for accomplishing a desired task. The challenge is that for a typical neural network, there may be millions of parameters to be optimized. Trying to optimize all these parameters from scratch may take hours, days, or even weeks, depending on the amount of computing resources available and the amount of data in the training set.

FIG. 5 illustrates a circuit block diagram of a computing machine 500 in accordance with some embodiments. In some embodiments, components of the computing machine 500 may store or be integrated into other components shown in the circuit block diagram of FIG. 5. For example, portions of the computing machine 500 may reside in the processor 502 and may be referred to as “processing circuitry.” Processing circuitry may include processing hardware, for example, one or more central processing units (CPUs), one or more graphics processing units (GPUs), and the like. In alternative embodiments, the computing machine 500 may operate as a standalone device or may be connected (e.g., networked) to other computers. In a networked deployment, the computing machine 500 may operate in the capacity of a server, a client, or both in server-client network environments. In an example, the computing machine 500 may act as a peer machine in peer-to-peer (P2P) (or other distributed) network environment. In this document, the phrases P2P, device-to-device (D2D) and sidelink may be used interchangeably. The computing machine 500 may be a specialized computer, a personal computer (PC), a tablet PC, a personal digital assistant (PDA), a mobile telephone, a smart phone, a web appliance, a network router, switch or bridge, or any machine capable of executing instructions (sequential or otherwise) that specify actions to be taken by that machine.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems/apparatus (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The computing machine 500 may include a hardware processor 502 (e.g., a central processing unit (CPU), a GPU, a hardware processor core, or any combination thereof), a main memory 504 and a static memory 506, some or all of which may communicate with each other via an interlink (e.g., bus) 508. Although not shown, the main memory 504 may contain any or all of removable storage and non-removable storage, volatile memory or non-volatile memory. The computing machine 500 may further include a video display unit 510 (or other display unit), an alphanumeric input device 512 (e.g., a keyboard), and a user interface (UI) navigation device 514 (e.g., a mouse). In an example, the display unit 510, input device 512 and UI navigation device 514 may be a touch screen display. The computing machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or another sensor. The computing machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The drive unit 516 (e.g., a storage device) may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the computing machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the computing machine 500 and that cause the computing machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526.

Some embodiments related to techniques for extracting and transferring feature representations between models. Given a source model and an input for which the model may provide a prediction, some embodiments enable the ability to extract new features from the source model formulating a set of new inputs. The new inputs can be transferred to a different model to improve its performance.

Some embodiments are related to the general problems of model selection and feature engineering. Model selection may include, among other things, the process of choosing between various statistical models given an input dataset. Generally, there are multiple ways to select a model. The model developer may have a set of criteria and manage the tradeoffs between them. Common criteria may include evaluative performance metrics, computing resources, and interpretability.

Evaluative performance metrics include numeric metrics of performance such as accuracy, precision, recall, F1-score, area under the curve (AUC), and receiver operating characteristic (ROC).

The F1-score is the harmonic mean of precision and recall. The F1-score may be calculated according to Equation (1) below, where tp is the proportion of true positives, fp is the proportion of false positives, and fn is the proportion of false negatives. Precision is defined in Equation (2). Recall is defined in Equation (3).

$$\text{F1} \text{=} \text{2} / \left({\text{recall}}^{\text{-1}} + {\text{precision}}^{\text{-1}}\right) = \text{tp} / \left(\text{tp} \text{+} \text{0} \text{.5} \left(\text{fp} \text{+} \text{fn}\right)\right)$$

$$\text{precision} \text{=} \text{tp} / \left(\text{tp} \text{+} \text{fp}\right)$$

$$\text{recall} \text{=} \text{tp} / \left(\text{tp} \text{+} \text{fn}\right)$$

The receiver operating characteristic (ROC) curve for an artificial intelligence or statistical model is created by plotting the true positive rate against the false positive rate at various threshold settings for the model. The ROC-AUC measures the area under the ROC curve.

Turning to computing resources, models are measured in terms of training time and single point inference time. Models may also be measured in the type of hardware and infrastructure required in production systems, such as the need for graphics processing units (GPUs) or distributed machines.

Turning to interpretability, models may have interpretability requirements through various business use cases such as model validation and/or bias mitigation. Interpretability is usually provided through the use of various techniques that create importance measures for features on particular instances or for global understanding of a model.

Some metrics to optimize, in some cases, may include the evaluative performance metrics. It is usually the case outside of overfitting, that more complex model algorithms will produce better performance metrics. More complex models lend themselves to orders of magnitude more parameters to learn. The number of parameters to learn is directly correlated to increasing the cost of the next set of criteria: compute resources and interpretability. The model selection decision will usually lie in assessing the relative gain of the first criteria compared to the cost to the compute and interpretability measures.

Feature Engineering may include, among other things, the process of applying functions and transforms on raw data to improve model performance. Feature engineering is usually informed by domain expertise, but this system and method allows feature engineering to be informed by the learned feature representations of a source model.

Some embodiments are based on the following. Some embodiments address the model selection problem by improving the evaluative metrics criteria with minimal tradeoff to other criteria.

Input models may include models that are implemented with machine learning libraries like Pytorch, Tensorflow, SKLearn or XGBoost. A destination model may satisfy desired selection criteria other than evaluative performance. A source model may have significant improvement on evaluative performance metrics over that model.

A computing machine (e.g., computing machine 100) may determine the relative influence of features used in the source model prediction. An influence method may be chosen that satisfies the property that the sum of all influences of a local explanation equals the model score of that instance. The computing machine selects a spline function (or, alternatively, any other curve function) and fits the raw data to the influence space for each feature.

As used herein, the term “spline” may include, among other things, a function defined piecewise by polynomials. An example spline function S(t) is shown in Equation (4), where k is a positive integer. For every integer i between 0 and k-1, Pᵢ(t) is a polynomial. For every integer i between 1 and k-1, Pᵢ(tᵢ) = Pᵢ₋₁(tᵢ).

$$S \left(t\right) = \left\{\begin{matrix}{P}_{0} \left(t\right) , {t}_{0} \leq t \leq {t}_{1} , \\ {P}_{1} \left(t\right) , {t}_{1} \leq t \leq {t}_{2} , \\ ⋮ \\ {P}_{k - 1} \left(t\right) , {t}_{k - 1} \leq t \leq {t}_{k} ,\end{matrix}\right)$$

In some embodiments, the computing machine creates a new input feature set by applying the spline function transform to all of the raw dataset. The computing machine may, in some cases, consolidate conceptually similar features by adding the output of all splines associated with those features. The computing machine may transfer the new feature set to the destination model by augmenting the original input and retrain the model.

As used herein, the term “curve” may include, among other things, a contiguous collection of points. A curve may include a line, a parabola, a sinusoid, a logarithmic curve, an exponential curve, and the like. A curve C may be defined by a mathematical function (e.g., C(t) = t², C(t) = sin(t), and the like) or a collection of mathematical functions.

The use of relative influences is useful to the feature extraction process for two main reasons. The use of relative influences creates a path of information from raw input features to the model output. For feature engineering to occur, a function may be able to be applied to the raw data values. Furthermore, some embodiments capture accurate feature representation to improve model evaluation metrics. Evaluation metrics for regression models may be applied to the model score whereas classification models may be based on the decision boundaries which are also dependent on model scores. In some embodiments, the influence methods that are utilized satisfy the definition that the sum of all influences of a local explanation equals the model score of that instance. This may tie the influence space to the model score and likewise the evaluation metrics.

The summed influence feature may be defined as follows. Let N denote the feature set. For n∈N, let X = (x₀...xₙ) denote an instance’s values. Let f represent the source model’s classification function. Let θ represent the source model’s parameters. The influence function φ may satisfy Equation (5), where b is any bias value.

$${\sum }_{i = θ}^{n} φ \left({x}_{{i}^{n}} θ\right) = f \left(X , θ\right) + b$$

Quantitative Input Influence (QII) measures the degree of influence that each input feature exerts on the outputs of the system. There are several variants of QII. Unary QII computes the difference in outputs arising from two related input distributions - the real distribution and a hypothetical (or counterfactual) distribution that is constructed from the real distribution to account for correlations among inputs. Unary QII can be generalized to a form of joint influence of a set of inputs, called Set QII. A third method defines Marginal QII, which measures the difference in output based on comparing training data with and without the specific input whose marginal influence we want to measure. Depending on the application, we may choose the training sets we compare in different ways, leading to several different variants of Marginal QII. QII satisfies the summed influence requirement through the efficiency property ensuring the system will properly capture the model’s feature representations towards the evaluation metrics.

Integrated Gradients (IG) also measures the degree of influence that each input feature contributes to the outputs of the system. This technique may be used with neural network models. The technique utilizes the gradients of the inputs with respect to the output. Utilizing the integration of the gradients with respect to a relative baseline X′ warrants the completeness axiom, defined in Equation (6). This matches the summed influence requirement, setting the bias value b to the model output of the baseline f(X′) which ensures the computing machine may properly capture the model’s feature representations towards the evaluation metrics.

$${\sum }_{i = 0}^{M} I n t e g r a t e d G r a d s \left({x}_{i}\right) = f \left(X\right) - f \left(X\right)$$

The computation of influences may be a relatively expensive computational task, so while it might be feasible to calculate influences for thousands of records, it might be less feasible to do for entire datasets that contain records on the order of millions or more. The use of spline fitting (or, alternatively, any other curve fitting) is a reasonable operation to apply in order to summarize and capture the feature representations of the source model.

FIG. 6 illustrates an example graph 600 relating feature value 610 to influence 620, and a curve 630 (e.g., a spline) fitting for predicting influence from feature value. Feature influences are sensitive and subject to feature interactions, which are less relevant when engineering transformations on single features. The influence sensitivity plot (ISP) of FIG. 6 demonstrates the distribution of influences of a feature, and the curve 630 indicates the general feature representation of the source model.

Fitting the curve 630 may extract the most prominent trends that a model learns for a feature while ignoring the interactions with other features. The choice of the curve is subject to generalization and regularization preferences. In some embodiments, the curve 630 (and similar curves for other models) may be a cubic spline.

Some embodiments are based on a three-step process. The steps are to calculate feature influences, create a feature representative spline (or other curve) function, and use that spline function as a preprocessing step in a new model.

The first part of the process, generating feature influences, leverages a model that may be called from python or java. Common model frameworks that apply are the sklearn and xgboost models. A second common model framework to distinguish between are neural network model frameworks such as pytorch, tensorflow, and keras. These frameworks allow computation of gradients, which may be used for IG influence computation.

If using QII as an influence measure, the influences may be stored in a pandas Dataframe object where the columns represent the features of the model and the rows represent data points for which we’ve computed the QIIs. Otherwise, for neural network models using IG, the model may be callable in its native framework that allows gradients to be computed. The gradients can be specified and aggregated to form an influence measure using, for example, the explainer Trulens library and may be accelerated considerably via a multithreaded graphics processing unit (GPU) or other multithreaded processing unit. Using the multithreaded processing unit, QII may be applied in parallel, using parallel threads, to explain a set of points. Each point computation may be independent. The influences generated may be stored in a pandas Dataframe object where the columns represent the features of the model and the rows represent data points.

To compute the representative splines (or other curves), the technique of spline fitting may be done by computing feature influences for at least a threshold number (e.g., 1000) of points. The Dataframe can then be passed to a spline fitting algorithm such as numpy’s polyfit function for each feature using raw feature values as the x-coordinates and the feature influences as the y-coordinates. Any degree polynomial can be chosen. In some cases, choosing a degree that is too high can result in overfitting, and choosing a degree that is too low can result in underfitting.

Numpy’s polyfit function may return coefficients for the polynomial function. The resulting output data structure may contain a pandas Dataframe with the rows representing features of the model, and columns representing polynomial coefficients. This data structure is small enough to save in a single file (e.g., a comma-separated values (CSV) file or pickle file) which can be loaded in a new model development environment. The model spline representations may be stored into a pandas Dataframe object.

In some embodiments, the computing machine preprocesses the splines to a new model. The output of the previous step procures a small file that can be transferred to a new model’s development environment. The preprocessing step requires that the spline be applied to every record in a training dataset. The polynomial function can be restored via calling numpy’s poly1d method for each feature’s set of coefficients, returning processing functions for each feature. The training dataset can then be looped, applying this function to each record.

One optimization to reduce the size of the extracted feature set may be to consolidate conceptually similar features. The process involves identifying these features. Examples can include features sourced from similar means, features falling under some parent theme, or in the case of temporal models, it can be all timesteps belonging to a parent feature. The next step is adding the output of the numpy poly1d methods for each of the grouped features, and treating it as a single feature instead. The tradeoff of consolidation is in interpretability. If the destination model is using the new features for interpretability reasons, it is beneficial to understand the group theme of the extracted features. The extreme example is to add all the feature spline outputs or features influences from the source model, which would be comparable to sending the source model output as a feature to the destination model.

In some embodiments, the computing machine augments the original dataset and retrains the destination model.

During the previous preprocessing stage, the computing machine may add the new features as an augmentation to the original dataset. The destination model may be identified that can be developed via a desired model development framework that better satisfies model selection criteria.

The augmented dataset may either be stored in memory immediately ready to send as input to a training operation or saved in a format that can be accessible by the new model’s framework. If stored in memory, the data structures may be pandas Dataframes for xgboost or Tensor objects for Tensorflow or Pytorch. If saved into a framework specific dataset file the file format may be CSV for xgboost, tfrecord for tensorflow, or common serialized file formats such as CSV, JavaScript Object Notation (JSON), Parquet, Protobuf, or Avro for use in distributed processing frameworks such as Spark or Elastic MapReduce. This new dataset may then be used to retrain a new model. Some embodiments relate to the process of saving extracted features from one model to another dataset for retraining.

Some examples of extracting and transferring feature representations between models are described below. The applicable use cases are not limited to these examples.

In one example, the source model is a classifier gradient boosting machine (GBM) model and the destination model is a linear model.

One use case is to extract and transfer feature representation from a XGBoost GBM model to a SKLearn Linear model. Using at least a threshold number (e.g., 1000) of points, feature influences should be calculated using the QII method. Splines may be fit for each feature, and applied to the raw dataset. The raw dataset in conjunction with applying the spline transformation can be used as additional input to a linear model for retraining. The evaluation metric improvements may closely follow with the source GBM model’s evaluation metrics. This is possible because the splines may capture the nonlinear trends that the GBM has learned that a linear model might not be able to capture.

In one example, the source model is a classifier recurrent neural network (RNN) model and the destination model is a GBM model.

One use case is to extract and transfer feature representation from a Tensorflow or Pytorch RNN model to a XGBoost GBM model. Using at least a threshold number (e.g., 1000) of points, feature influences may be calculated using the IG method. QII may also be applicable, but IG may be faster to compute given the availability of the gradients and more accurate given the direct functional approximation of the model score that IG ensures.

In an RNN model, each timestep/feature pair is regarded as an independent input for the model and the feature influences. Due to the architecture of the RNN, each timestep for the same feature may undergo similar functional transformations in the RNN cell. Thus, it is the case that these be adequately related so as to treat the coalition of all timesteps of a feature as a single feature. Because of the additive principle of influences guaranteed by the completeness axiom, a sum of these features is an equivalently valid representation of a feature as per the source model. In some cases, the relation of influences between timesteps can reflect the behavior of traditional time series feature engineering techniques such as exponential decay or signal processing. FIGS. 7A-7F illustrate a series of influence sensitivity plots (ISPs) 702 in FIG. 7A, 704 in FIG. 7B, 706 in FIG. 7C, 708 in FIG. 7D, 710 in FIG. 7E, and 712 in FIG. 7F of one feature partitioned by time. These ISPs 702 in FIG. 7A, 704 in FIG. 7B, 706 in FIG. 7C, 708 in FIG. 7D, 710 in FIG. 7E, and 712 in FIG. 7F demonstrate temporal feature representations.

FIG. 8 illustrates an influence sensitivity plot (ISP) 800 focusing on the time dimension showcasing temporal feature representation. The temporal feature representation of FIG. 8 is similar to an attenuating signal. This feature engineering extracted from an RNN model might be difficult for a GBM to create without leveraging the technology disclosed herein, as a GBM might not use temporally indexed features. In some cases, the GBM algorithm does not explicitly model for temporal relationships.

Some embodiments apply for transferring feature representations from any model that can create a decision boundary that is difficult or impossible for another model to create with its own algorithm. For example, a GBM or other tree models operate by creating orthogonal hyperplane breakpoints in the dataspace. A linear model is not constrained in the same way and can create hyperplane partitions of the space that are not orthogonal. It can be the case that different statistical models cover entirely different boundary creation techniques. Thus, in some embodiments, it is feasible to extract features from a linear model into a GBM and vice versa as well.

While it is not strictly impossible that this process will not do well if the method of boundary creation is the same between the models, it can be hypothesized that if there was a good feature, each of the models could already have created it independently. For example, multilayer perceptron (MLP) neural networks use linear operations as a subroutine so extracting a linear model into a MLP network might not be as effective. Some considerations as to why it could have some efficacy is that linear models are better regularized, meaning that the MLP neural network might not create the simpler but potentially better linear features.

Some embodiments relate to preserving alternative model selection criteria.

Some embodiments address the model selection problem by improving the evaluative metrics criteria with minimal tradeoff to other criteria. The techniques described may be sufficient to demonstrate improvement to the evaluative metrics criteria. Some embodiments might not address the minimal tradeoff to other criteria.

One criterion of model selection outlined herein is preserving compute resources. Typically, there are two stages of evaluation for a model - training computation time and inference computation time. The tradeoff in model selection for compute resources is driven by the more complex model algorithm and construction causing both of these computations to take longer. A GBM has orders of magnitude more parameters than a linear model, and a neural network has orders of magnitude more parameters than a GBM. Given the features are transferred to a model that already satisfies the compute resource constraints, the system does not impose any more compute dependencies that come with more complex model algorithms. This system only adds computation requirements associated with adding more features, which is a very common iterative practice in model development. Any infrastructure requirements such as the need for GPU or distributed environments can be satisfied by extracting features into a model that can operate on the desired infrastructure.

One criterion of model selection is interpretability. Generally, the simpler model algorithms have a propensity towards simpler methods and efficacy on interpretability. For linear models, the low number of parameters allows one to simply look at a multiplicative importance weight with a bias to explain general importance of features as they relate to any other feature in the model. For GBM models, the decision trees themselves can be visualized, or common model explanation libraries such as SHAP (Shapley additive explanations) and LIME (local interpretable model-agnostic explanations) may be in use in many production systems. Since the final model benefiting from the feature engineering is chosen to be sufficient in interpretability, the same techniques can be applied. Therefore, the missing link in the interpretability evaluation may be the feature engineering itself. Since the feature engineering is based on spline (or other curve) fitting on the raw data, the spline itself can be used as an explanation medium on the data. The splines outline the general trends of the features as learned by the source model and can be examined independently.

Some embodiments relate to determining the relative influence of features. Some embodiments allow a computing machine to extract feature representations from black box models (e.g., neural networks). Some embodiments use feature influences to transfer extracted features between models of entirely different types.

FIG. 9 is a flowchart of an example process 900 associated with extracting and transferring feature representations between models. In some implementations, one or more process blocks of FIG. 9 may be performed by a computing machine (e.g., computing machine 100). In some implementations, one or more process blocks of FIG. 9 may be performed by another device or a group of devices separate from or including the computing machine. Additionally, or alternatively, one or more process blocks of FIG. 9 may be performed by one or more components of the computing machine 500, such as processor 502, main memory 504, static memory 506, network interface device 520, video display 510, alpha-numeric input device 512, UI navigation device 514, drive unit 516, signal generation device 518, and output controller 528.

As shown in FIG. 9, process 900 may include accessing, at a computing machine, a source model and a destination model, wherein the source model and the destination model are artificial intelligence or statistical models, wherein each of the source model and the destination model is configured to compute an output value based on an input value vector, wherein the input value vector comprises values for each of a set of features (block 910). For example, the computing machine may access a source model and a destination model, wherein the source model and the destination model are artificial intelligence or statistical models, wherein each of the source model and the destination model is configured to compute an output value based on an input value vector, wherein the input value vector comprises values for each of a set of features, as described above.

As further shown in FIG. 9, process 900 may include developing an influence model for the source model, wherein the influence model computes a relative influence value for one or more feature of the source model, wherein a sum of all relative influence values corresponds to the output value of the source model (block 920). For example, the computing machine may develop an influence model for the source model, wherein the influence model computes a relative influence value for one or more features of the source model, wherein a sum of all relative influence values corresponds to the output value of the source model, as described above.

As further shown in FIG. 9, process 900 may include determining, using a curve fitting engine and based on the influence model, a curve function mapping the one or more features of the source model to the relative influence value of the one or more features (block 930). For example, the computing machine may determine, using a curve fitting engine and based on the influence model, a curve function mapping the one or more features of the source model to the relative influence value of the one or more features, as described above.

As further shown in FIG. 9, process 900 may include creating an augmented input feature set by applying the curve function to augment the one or more features of the source model (block 940). For example, the computing machine may create an augmented input feature set by applying the curve function to augment the one or more features of the source model, as described above.

As further shown in FIG. 9, process 900 may include modifying the destination model by adding, to the destination model, a preprocessing function to generate feature values for features of the augmented input feature set (block 950). For example, the computing machine may modify the destination model by adding, to the destination model, a preprocessing function to generate feature values for features of the augmented input feature set, as described above.

As further shown in FIG. 9, process 900 may include retraining the modified destination model to leverage the curve function and the augmented input feature set (block 960). For example, the computing machine may retrain the modified destination model to leverage the curve function and the augmented input feature set, as described above.

As further shown in FIG. 9, process 900 may include providing a representation of the retrained modified destination model (block 970). For example, the computing machine may provide a representation of the retrained modified destination model, as described above.

Process 900 may include additional implementations, such as any single implementation or any combination of implementations described below and/or in connection with one or more other processes described elsewhere herein.

In a first implementation, the relative influence value is computed based on a quantitative input influence (QII) score computed based on a joint influence of a set of one or more features or a difference in outputs with or without the one or more features from the one or more features.

In a second implementation, the joint influence corresponds to a correlation.

In a third implementation, process 900 includes storing a table data structure where columns represent the one or more features and rows represent the QII score.

In a fourth implementation, the relative influence value is computed based on a sum of gradients of an interpolation between a baseline value and the output value of the source model with respect to the one or more features, wherein the source model comprises an artificial neural network (ANN).

In a fifth implementation, gradients used in the sum of gradients are computed in parallel using multithreaded processing circuitry.

In a sixth implementation, the curve function comprises a spline function.

In a seventh implementation, the curve fitting engine maps feature values to feature influences using a n-degree polynomial, wherein n is a positive integer.

In an eighth implementation, the curve fitting engine mathematically combines the one or more features of the source model into a single feature based on the one or more features having a correlation with one another exceeding a threshold value or being sourced from a similar source.

In a ninth implementation, the generated feature values for features of the augmented input feature set are stored in a memory of the computing machine.

In a tenth implementation, the generated feature values for features of the augmented input feature set are stored, in a data repository external to the computing machine, in a format that is accessible to the destination model for retraining the destination model.

In an eleventh implementation, the source model comprises a classifier gradient boosting machine (GBM) model, and wherein the destination model comprises a linear model.

In a twelfth implementation, the source model comprises a classifier recurrent neural network (RNN) model, and wherein the destination model comprises a classifier gradient boosting machine (GBM) model.

In a thirteenth implementation, the destination model and the modified destination model utilize fewer computing resources than the source model, wherein the computing resources comprise processing circuitry resources or memory resources.

In a fourteenth implementation, the source model utilizes a server farm having a first amount of memory, and wherein the destination model and the modified destination model utilize a client computing device having a second amount of memory, the second amount of memory being less than the first amount of memory.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

Some embodiments are described as numbered examples (Example 1, 2, 3, etc.). These are provided as examples only and do not limit the technology disclosed herein.

Example 1 is a method comprising: accessing, at a computing machine, a source model and a destination model, wherein the source model and the destination model are artificial intelligence or statistical models, wherein each of the source model and the destination model is configured to compute an output value based on an input value vector, wherein the input value vector comprises values for each of a set of features; developing an influence model for the source model, wherein the influence model computes a relative influence value for one or more feature of the source model, wherein a sum of all relative influence values corresponds to the output value of the source model; determining, using a curve fitting engine and based on the influence model, a curve function mapping the one or more features of the source model to the relative influence value of the one or more features; creating an augmented input feature set by applying the curve function to augment the one or more features of the source model; modifying the destination model by adding, to the destination model, a preprocessing function to generate feature values for features of the augmented input feature set; and retraining the modified destination model to leverage the curve function and the augmented input feature set; and providing a representation of the retrained modified destination model.

In Example 2, the subject matter of Example 1 includes, wherein the relative influence value is computed based on a quantitative input influence (QII) score computed based on a joint influence of a set of one or more features or a difference in outputs with or without the one or more features from the one or more features.

In Example 3, the subject matter of Example 2 includes, wherein the joint influence corresponds to a correlation.

In Example 4, the subject matter of Examples 2-3 includes, storing a table data structure where columns represent the one or more features and rows represent the QII score.

In Example 5, the subject matter of Examples 1-4 includes, wherein the relative influence value is computed based on a sum of gradients of an interpolation between a baseline value and the output value of the source model with respect to the one or more features, wherein the source model comprises an artificial neural network (ANN).

In Example 6, the subject matter of Example 5 includes, wherein gradients used in the sum of gradients are computed in parallel using multithreaded processing circuitry.

In Example 7, the subject matter of Examples 1-6 includes, wherein the curve function comprises a spline function.

In Example 8, the subject matter of Examples 1-7 includes, wherein the curve fitting engine maps feature values to feature influences using a n-degree polynomial, wherein n is a positive integer.

In Example 9, the subject matter of Examples 1-8 includes, wherein the curve fitting engine mathematically combines the one or more features of the source model into a single feature based on the one or more features being having a correlation with one another exceeding a threshold value or being sourced from a similar source.

In Example 10, the subject matter of Examples 1-9 includes, wherein the generated feature values for features of the augmented input feature set are stored in a memory of the computing machine.

In Example 11, the subject matter of Examples 1-10 includes, wherein the generated feature values for features of the augmented input feature set are stored, in a data repository external to the computing machine, in a format that is accessible to the destination model for retraining the destination model.

In Example 12, the subject matter of Examples 1-11 includes, wherein the source model comprises a classifier gradient boosting machine (GBM) model, and wherein the destination model comprises a linear model.

In Example 13, the subject matter of Examples 1-12 includes, wherein the source model comprises a classifier recurrent neural network (RNN) model, and wherein the destination model comprises a classifier gradient boosting machine (GBM) model.

In Example 14, the subject matter of Examples 1-13 includes, wherein the destination model and the modified destination model utilize fewer computing resources than the source model, wherein the computing resources comprise processing circuitry resources or memory resources.

In Example 15, the subject matter of Examples 13-14 includes, wherein the source model utilizes a server farm having a first amount of memory, and wherein the destination model and the modified destination model utilize a client computing device having a second amount of memory, the second amount of memory being less than the first amount of memory.

Example 16 is at least one machine-readable medium including instructions that, when executed by processing circuitry, cause the processing circuitry to perform operations to implement of any of Examples 1-15.

Example 17 is an apparatus comprising means to implement of any of Examples 1-15.

Example 18 is a system to implement of any of Examples 1-15.

Example 19 is a method to implement of any of Examples 1-15.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, user equipment (UE), article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing, at a computing machine, a source model and a destination model, wherein the source model and the destination model are artificial intelligence or statistical models, wherein each of the source model and the destination model is configured to compute an output value based on an input value vector, wherein the input value vector comprises values for each of a set of features;
developing an influence model for the source model, wherein the influence model computes a relative influence value for one or more feature of the source model, wherein a sum of all relative influence values corresponds to the output value of the source model;
determining, using a curve fitting engine and based on the influence model, a curve function mapping the one or more features of the source model to the relative influence value of the one or more features;
creating an augmented input feature set by applying the curve function to augment the one or more features of the source model;
modifying the destination model by adding, to the destination model, a preprocessing function to generate feature values for features of the augmented input feature set;
retraining the modified destination model to leverage the curve function and the augmented input feature set; and
providing a representation of the retrained modified destination model.

2. The method of claim 1, wherein the relative influence value is computed based on a quantitative input influence (QII) score computed based on a joint influence of a set of one or more features or a difference in outputs with or without the one or more features from the one or more features.

3. The method of claim 2, wherein the joint influence corresponds to a correlation.

4. The method of claim 2, further comprising:
storing a table data structure where columns represent the one or more features and rows represent the QII score.

5. The method of claim 1, wherein the relative influence value is computed based on a sum of gradients of an interpolation between a baseline value and the output value of the source model with respect to the one or more features, wherein the source model comprises an artificial neural network (ANN).

6. The method of claim 5, wherein gradients used in the sum of gradients are computed in parallel using multithreaded processing circuitry.

7. The method of claim 1, wherein the curve function comprises a spline function.

8. The method of claim 1, wherein the curve fitting engine maps feature values to feature influences using a n-degree polynomial, wherein n is a positive integer.

9. The method of claim 1, wherein the curve fitting engine mathematically combines the one or more features of the source model into a single feature based on the one or more features being having a correlation with one another exceeding a threshold value or being sourced from a similar source.

10. The method of claim 1, wherein the generated feature values for features of the augmented input feature set are stored in a memory of the computing machine.

11. The method of claim 1, wherein the generated feature values for features of the augmented input feature set are stored, in a data repository external to the computing machine, in a format that is accessible to the destination model for retraining the destination model.

12. The method of claim 1, wherein the source model comprises a classifier gradient boosting machine (GBM) model, and wherein the destination model comprises a linear model.

13. The method of claim 1, wherein the source model comprises a classifier recurrent neural network (RNN) model, and wherein the destination model comprises a classifier gradient boosting machine (GBM) model.

14. The method of claim 1, wherein the destination model and the modified destination model utilize fewer computing resources than the source model, wherein the computing resources comprise processing circuitry resources or memory resources.

15. The method of claim 13, wherein the source model utilizes a server farm having a first amount of memory, and wherein the destination model and the modified destination model utilize a client computing device having a second amount of memory, the second amount of memory being less than the first amount of memory.

16. A system comprising:
a memory comprising instructions; and
one or more computer processors, wherein the instructions, when executed by the one or more computer processors, cause the system to perform operations comprising:
accessing a source model and a destination model, wherein the source model and the destination model are artificial intelligence or statistical models, wherein each of the source model and the destination model is configured to compute an output value based on an input value vector, wherein the input value vector comprises values for each of a set of features;
developing an influence model for the source model, wherein the influence model computes a relative influence value for one or more feature of the source model, wherein a sum of all relative influence values corresponds to the output value of the source model;
determining, using a curve fitting engine and based on the influence model, a curve function mapping the one or more features of the source model to the relative influence value of the one or more features;
creating an augmented input feature set by applying the curve function to augment the one or more features of the source model;
modifying the destination model by adding, to the destination model, a preprocessing function to generate feature values for features of the augmented input feature set;
retraining the modified destination model to leverage the curve function and the augmented input feature set; and
providing a representation of the retrained modified destination model.

17. The system as recited in claim 16, wherein the relative influence value is computed based on a quantitative input influence (QII) score computed based on a joint influence of a set of one or more features or a difference in outputs with or without the one or more features from the one or more features.

18. The system as recited in claim 17, wherein the joint influence corresponds to a correlation.

19. The system as recited in claim 17, wherein the instructions further cause the one or more computer processors to perform operations comprising:
storing a table data structure where columns represent the one or more features and rows represent the QII score.

20. A tangible machine-readable storage medium including instructions that, when executed by a machine, cause the machine to perform operations comprising:
accessing a source model and a destination model, wherein the source model and the destination model are artificial intelligence or statistical models, wherein each of the source model and the destination model is configured to compute an output value based on an input value vector, wherein the input value vector comprises values for each of a set of features;
developing an influence model for the source model, wherein the influence model computes a relative influence value for one or more feature of the source model, wherein a sum of all relative influence values corresponds to the output value of the source model;
determining, using a curve fitting engine and based on the influence model, a curve function mapping the one or more features of the source model to the relative influence value of the one or more features;
creating an augmented input feature set by applying the curve function to augment the one or more features of the source model;
modifying the destination model by adding, to the destination model, a preprocessing function to generate feature values for features of the augmented input feature set;
retraining the modified destination model to leverage the curve function and the augmented input feature set; and
providing a representation of the retrained modified destination model.
